(19) United States
(12) Patent Application Publication
(10) Pub. No.: US 2004/0076321 A1
(43) Pub. Date: Apr. 22, 2004

(54) Non-oriented optical character recognition of a wafer mark

(76) Inventors: Frank Evans, Dundee, OR (US); Fulton Li, Beaverton, OR (US)

Correspondence Address: Thomas E. Bejin, YOUNG & BASILE PC, Suite 624, 3001 West Big Beaver Road, Troy, MI, 48084-3071, US

(21) Appl. No.: 10/620,192

(22) Filed: Jul. 15, 2003

Related U.S. Application Data
(60) Provisional application No. 60/396,231, filed on Jul. 16, 2002.

(51) Int. Cl. G06K 9/00; G06K 9/18

(52) U.S. Cl. 382/141; 382/182

(57) ABSTRACT

A non-oriented optical character recognition device and method for locating and reading identification markings on silicon wafers positioned in any orientation without having to physically manipulate the silicon wafer.

### CROSS-REFERENCE TO RELATED APPLICATION

This application claims the benefit of U.S. Provisional Patent Application No. 60/396231, filed on Jul. 16, 2002.

### FIELD OF THE INVENTION

The present invention relates to inspection of products bearing minute product identifiers. In particular, the invention provides for a non-oriented optical character recognition device and method to read silicon wafer identification marks.

### BACKGROUND OF THE INVENTION

Semiconductor processing involves the inspection of wafers having multiple semiconductor devices. These wafers utilize distinctive markings to allow tracking of an individual wafer through the production process. Typically, these markings are character based, but recently have evolved into other coding mechanisms. Ordinarily, the wafer is circular, with a notch or flat to indicate a unique orientation of the wafer.

In the prior art, the recognition of the wafer mark involves three distinct steps often carried out at two distinct stations taking up valuable space, requiring dedicated equipment and individual process time. The first step involves determining the location of the center of the wafer and the orientation of the wafer by finding the notch or the flat. Once the location and orientation of the wafer is determined, the location of the mark can be calculated, and a mechanical device rotates the wafer such that the mark is properly oriented for presentation of the mark into the viewing area of a camera. Once presented to the camera, the wafer identification markings can be interpreted and the information contained therein extracted from the camera. This three-step process is problematic in that it is costly and time consuming and a further need exists to reduce the time involved in interpreting the information contained in the wafer mark.

Consequently, it would be desirable to provide an apparatus and method for locating a silicon wafer mark without having to physically manipulate or reorient the wafer. It would also be desirable to provide an apparatus and method that reduces the time of wafer identification, increases the accuracy of the identification process and is economical to implement and operate.

### SUMMARY OF THE INVENTION

The inventive apparatus and method provides a camera positioned along a path of travel sequentially transporting a plurality of silicon wafers each having distinctive markings particular to each wafer.

The camera rapidly and sequentially takes a plurality of line images of each wafer as the wafers move along the path of travel. An illumination device is also positioned along the path of travel and sequentially projects different types or forms of illumination in a synchronous manner as the camera takes the line images producing a single image of each wafer made from the plurality of line images each of alternate illumination. A processor including software components monitors the illumination device and the motion and rate of travel of the path of travel.

The single, interlaced wafer image is received and separated by the processor software into individual wafer images, each image being of only the same type of illumination. The separated wafer images of the same illumination type are examined by the processor and the image which most clearly defines the wafer is selected and the wafer edge, wafer notch and approximate center of the wafer are located by the processor. An area containing or housing the wafer markings is also located by the processor.

The located area containing the wafer markings is examined by software in the processor and the wafer markings therein are read and the wafer identified.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a schematic representation of the present invention;

FIG. 2 is a schematic representation of a silicon wafer image;

FIG. 3 is an enlarged image of the wafer mark taken from FIG. 2;

FIG. 4 is a schematic representation of the software utilized; and

FIG. 5 is a schematic representation of a flowchart of an aspect of the inventive method.

### DESCRIPTION OF THE PREFERRED EMBODIMENT

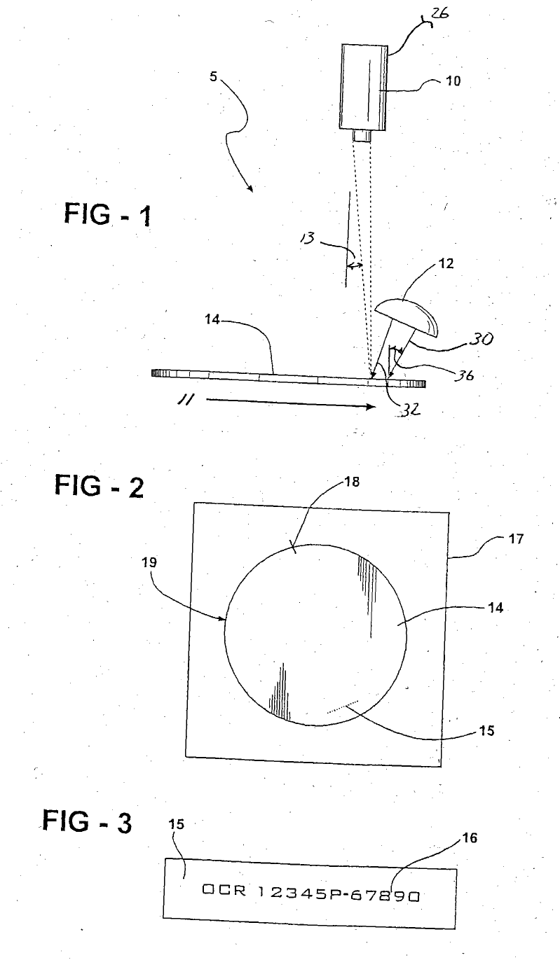

Referring to FIGS. 1 through 5, a non-oriented optical character recognition device and method is illustrated. The optical character recognition device 5 provides a method and an apparatus to efficiently and systematically identify the scribe or identification markings on a silicon wafer 14 traveling along a path of travel 11 of a wafer processing line regardless of the physical orientation of the wafer.

This is accomplished by placing the character recognition apparatus 5 of the present invention along a new or existing processing path of travel 11 such that one or more silicon wafers 14 (one shown) are in motion, for example, traveling from a processing chamber to another processing chamber or from a cassette to a processing chamber (not shown). Referring to FIG. 1, a high resolution line scan camera 10 and an illumination device 12 capable of multiple types of illumination as further described below are positioned along the path of travel 11.

Illumination device 12 is positioned along and above path of travel 12 as shown in FIG. 1. Illumination device 12 includes and projects a plurality of illumination types at different angles with respect to the vertical or normal to wafer 14, which, by way of example, may include bright field illumination 30, dark field illumination 32, illumination with incandescent lighting (not shown), and illumination with LED lighting (not shown), among others.

In a preferred aspect, line scan camera 10 is a charge-coupled device-type line scan camera positioned at a first angle 13 with respect to the vertical or normal to wafer 14. It is understood that the bright field illumination form of light 30 produced by the illumination device 12 has a second angle 36 from vertical or normal to wafer 14 that is complementary or symmetrical to the angle 13 of camera 10 to permit bright field illumination of wafer 14 without the need for a beam splitter. It is further understood by those skilled in the art that when utilized, the bright field illumination form of light 30 provides a bright background directly into camera 10 and the dark field illumination form of light provides a black background.

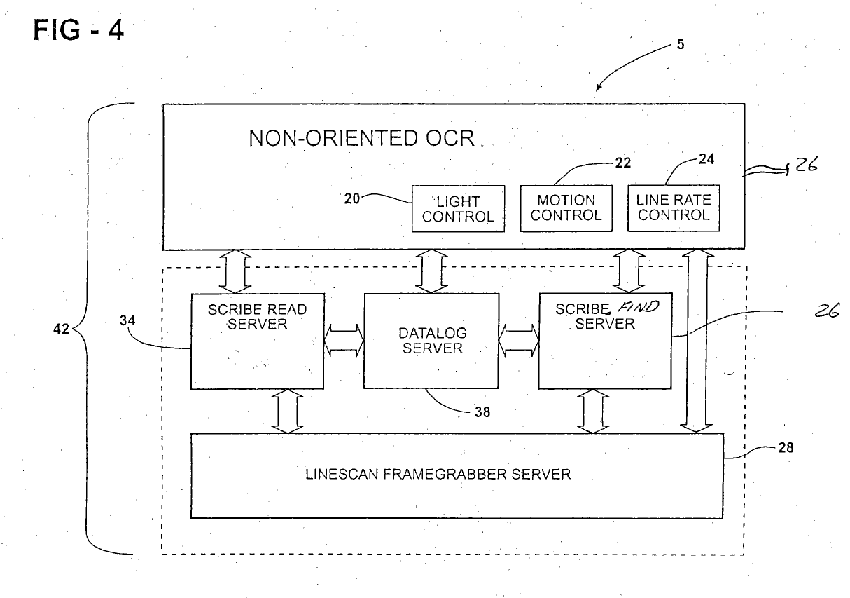

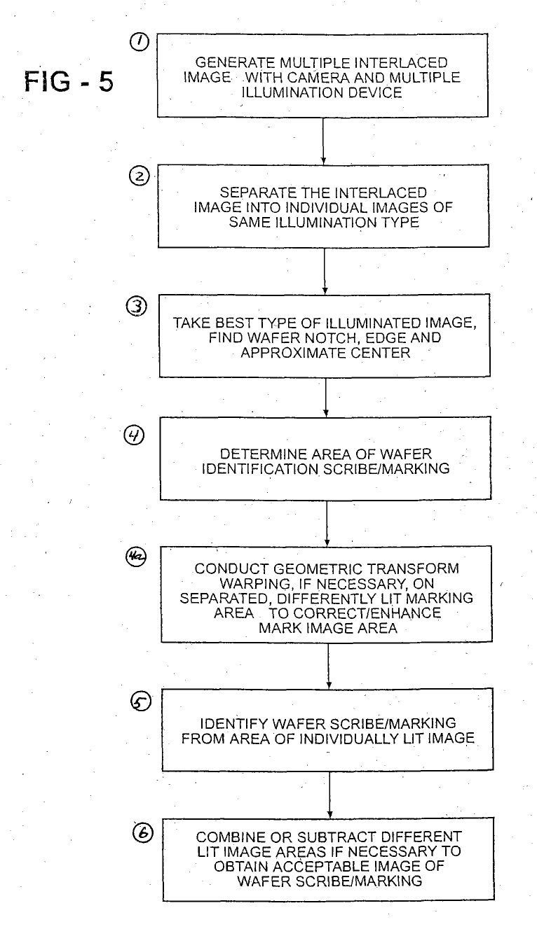

As wafer 14 progresses along the path of travel 11 and passes within the field of view of camera 10 in any orientation, camera 10 rapidly and sequentially takes a plurality of line images of wafer 14. For each incremental line image that is taken, the multiple illumination device 12 changes or alternates to a different type of illumination, for example, a line image taken under bright field illumination 30, followed by a line image taken using dark field illumination 32, followed by a line image taken with incandescent lighting, followed by another line image taken with bright field illumination 30, followed by another line image taken with dark field illumination 32 and so on. This represents, for example, a line image taking sequence with a multiple illumination device 12 with three different types of illumination. Sequential line images taken by camera 10 using different types of illumination per line image produce a single interlaced wafer image 17 made from multiple and repeating patterns of individual line images taken with the predetermined different types of illumination described above (step 1 in FIG. 5). This process of rapidly taking line images under different types of illumination continues until the wafer 14 has been fully imaged and a single wafer image 17 is produced. The multiple interlaced line images taken as image 17 are received by a processor 42 which includes a first software component, a linescan capture or frame grabber 28, on a server that is in electronic communication with the camera 10 and software components 20, 22, 24 through cable 26 as shown in FIG. 4 and more fully described below.

In an alternate aspect of the invention, at least one, and preferably at least two high resolution line image taking devices, not shown, may be used in place of the charge coupled device camera 10 previously described. These line image devices provide for a 1:1 image of wafer 14 and are positioned parallel to one another transverse to the path of travel 11 in close proximity to wafer 14. The parallel line image devices optically scan and produce 1:1 multiple interlaced line images in a single image 17 similar to those described above. For example, two parallel positioned line scan images could be used, one for bright field illumination 30 and one for dark field illumination 32 which produces similar images to a charge coupled device camera using a bright field illumination 30 and a dark field illumination 32. In this aspect, a separate parallel line imager is needed for each type of illumination and a single or several multiple illumination devices 12 may be employed.

Referring to FIG. 4, the character recognition device 5 further includes a processor 42 in electronic communication with camera 10 and illuminator 12. The processor 42 includes a first software line scan component 28, a second software component 20 to monitor or control the multiple illuminator device 12, a third software component 22 to monitor or control the movement of the path of travel 11, and a fourth software component 24 to monitor or control the line rate or velocity of the path of travel 11. If the character recognition devices are added to an existing path of travel 11, the preference would be to monitor the existing movement and line rate. If device 5 is designed into a new path, active controlling may additionally be preferred. The second through fourth software components 20, 22, 24 respectively and computer hardware associated therewith (not shown), may be positioned near the camera 10 and illuminator 12 or in a distant area of the facility.

Following the taking of the single interlaced image 17 of wafer 14 made up from multiple line images taken under different illumination types, a fifth software component, SCRIBE FIND 26, in processor 42 is used to locate an area 15 on wafer 14 where the scribe or wafer identification marking 16 would typically be located as best seen in FIG. 3. This is accomplished by first separating image 17 into its multiple interlaced line images by illumination type (step 2 FIG. 5). Due to the many, possibly thousands, of sequential line images taken under each type of illumination, this separation produces a complete image of wafer 14 for each of the different types of illumination. For example, the separated line images will produce one complete image of wafer 14 taken under the bright field illumination 30, one for the dark field illumination 32, and one for the incandescent light illumination. Under processing conditions that produce a separated image where features of the wafer can clearly be identified, the best complete wafer image 17 of the separated images of different illuminations is selected and used to locate and identify the wafer edge 19, wafer notch or flat 18, and to approximate the center of the wafer 14 (not shown) (step 3 FIG. 5). It is typical to use the bright field illumination 30 image to find the wafer edge 19, wafer notch 18, and to approximate the center.

To find the wafer edge 19, wafer notch 18, and center of the wafer, the circumferential edge 19 of wafer 14 is examined to identify the notch 18 which is purposely manufactured into the wafer 14 for such purposes. Once the circumferential edge 19 of the round wafer is examined and notch 18 is located, the center of the wafer is accurately located through projection of radii (not shown) from the circumference edge 19. These identifications of the wafer edge 19, wafer notch 18, and wafer center are carried out in the fifth software component, a SCRIBE FIND 26 in electronic communication with the first 28 through fourth 24 software components described above and illustrated in FIG. 4.

Referring to FIG. 2, once the notch 18 and center are identified, a relatively small area 15 on wafer 14 may be identified which typically contains the wafer scribe or identification markings 16 as shown in FIGS. 2 and 3 (step 4 FIG. 5). Identification of this relatively small area 15 greatly narrows the search and this reduces the burden of close examination of the images to find the wafer marking 16. This efficient method is further accomplished without independent and mechanical processes at individual stations or physically moving or reorienting the wafer 14 to first, locate area 15 and second, to present area 15 of the wafer to a location where the markings 16 can be examined for identification.

Next, a sixth software component, SCRIBE READ 34, is used to view or read the wafer mark 16 in area 15 (step 5 FIG. 5). In the sixth SCRIBE READ component 34, area 15 is examined and analyzed to determine whether an acceptable view or image of the identification mark 16 is obtainable from that particular marker area 15. The mark area 15 may further be electronically rotated, enlarged or manipulated for improved viewing of area 15 without having to physically reposition the physical wafer 14. If the image area 15 of the selected image produces an acceptable view or reading of the identification scribe/mark 16, a positive identification of the wafer 14 may be obtained and the remaining image areas 15 need not be examined. Conventional methods known to those of skill in the art may then be used to recognize and decode the mark 16 in the image area 15. The interpretation or reading of the mark area 15 image and mark 16 is then stored in a seventh software component, a data log 38, in processor 42 which is in electronic communication with first 20 through sixth 34 software components of device 5 as described above and illustrated in FIG. 4.

Prior to positive identification of mark 16, depending on variables in the existing wafer 14 and processing conditions, oval or oblong images of circular wafer 14 or area 15 may be generated. Such potential distortions of the image taken of the typically round wafer 14 may occur, for example, due to nonlinear movement of wafer 14 on line path 11 including accelerations and curved trajectories, or the angle 13 of camera 10 to the surface of wafer 14. To account for these potential distortions on the separated illumination images, an intermediate step may be taken. Geometric transforms or warps of the taken image areas 15 may be conducted in the processor 42 to enhance or correct the taken images (step 4a FIG. 5).

To increase efficiency and to reduce processing and computation time, geometric transforming of the image is conducted only over the small mark area 15 identified by the inventive process. This geometric transforming and examination of area 15 taken under the selected illumination is conducted in the sixth software component 34 in the processor 42 which is in electronic communication with the software components first 28 through fifth 26 as illustrated in FIG. 4. Under the inventive apparatus and process, it is not necessary to perform a geometric transform on the entire image 17 prior to the edge 19, notch 18 and center finding steps, and it is acceptable to perform these notch, edge and center finding steps on the distorted image and to then apply a mathematically equivalent transform to the extracted notch, edge and center data, image area 15 and mark 16.

If the selected and separated image under the same illumination does not yield an acceptable image of mark 16, it may be necessary to examine and locate all of the separated images under different illumination, the edge 19, notch 18, center and area 15 for that image. Under this aspect, each area 15 of each of the separated images is examined, and if further necessary, geometrically transformed to produce an acceptable image of mark 16.

If none of the individual, separated marker image areas 15 taken under different illumination types provides an acceptable view or image of the identification scribe/mark 16, two or more of the separated image areas 15 taken at different illuminations may be combined or subtracted in various combinations in the sixth scribe read software component 34 to provide an acceptable image of the identification scribe/mark 16 (step 6 FIG. 5).

The result of the inventive apparatus and method is the ability to use a high resolution line scan camera 10 and multiple illumination device 12 to generate a readable image of the wafer mark 16 in any orientation of wafer 14 on the path of travel 11 without requiring separate equipment to physically move or reorient the wafer 14. The high resolution of the line scan image allows the device and method 5 to identify the location area 15 of mark area 16, geometrically transform and manipulate the mark area 15, if necessary, and extract the mark 16 without other separate stations, mechanical processes or assistance. It also permits all of the data to be captured in a single pass along the path of travel 11, without any iterative adjustment to the lighting.

While the invention has been described in connection with what is presently considered to be the most practical and preferred embodiment, it is to be understood that the invention is not to be limited to the disclosed embodiments.

What is claimed:

1. A non-oriented optical character recognition apparatus for use in locating and reading markings on a silicon wafer moving along a path of travel, the apparatus comprising:
a camera positioned along the path of travel for taking a plurality of sequential line images of the silicon wafer on the path of travel to produce a first wafer image;
an illumination device positioned along the path of travel for projecting at least two different types of illumination along the path of travel intersected by the wafer in the area that the line images are taken, the illumination device is adapted to change the type of illumination in a synchronous manner with the taking of the plurality of line images; and
a processor in electronic communication with the camera for separating the line images from the first wafer image into at least two separate wafer images of different illumination, identifying the wafer marking on at least one of the at least two wafer images of different illumination, and reading the wafer mark.

2. The optical character recognition apparatus of claim 1 wherein the camera is positioned above and at a first angle from the vertical with respect to the first path of travel.

3. The optical character recognition device of claim 2 wherein the camera is a charge coupled device camera.

4. The optical character recognition apparatus of claim 2 wherein the camera further comprises at least two individual cameras positioned adjacent one another and transverse to the path of travel.

5. The optical character recognition apparatus of claim 1 wherein the at least two different types of illumination include a bright field illumination, a dark field illumination, an incandescent illumination and LED illumination.

6. The optical character recognition apparatus of claim 1 wherein the illumination device is positioned above and at a second angle from the vertical with respect to the first path of travel.

7. The optical character recognition apparatus of claim 6 wherein the second angle of the illumination device is substantially equal to a first angle position of the camera from the vertical and substantially symmetric about the vertical.

8. The optical character recognition apparatus of claim 1 wherein the processor includes a first computer software component that receives the line images from the camera.

9. The optical character recognition apparatus of claim 1 wherein the processor further comprises a second, third and fourth computer software component in electronic communication with the camera, illumination device and line path for monitoring the illumination device, movement of the path of travel and the rate of the path of travel respectively.

10. The optical character recognition apparatus of claim 9 wherein the second, third and fourth computer software components control the illumination device, movement of the line path of travel and the rate of the path of travel respectively.

11. The optical character recognition apparatus of claim 1 wherein the processor further comprises a fifth computer software component for locating an identifiable area wherein the wafer markings are located.

12. The optical character recognition apparatus of claim 11 wherein the fifth software component locates an edge of the wafer, an edge notch of the wafer, the center of the wafer, and the area containing the wafer markings.

13. The optical character recognition apparatus of claim 1 wherein the processor further comprises a sixth software component for reading the wafer mark.

14. A non-oriented optical character recognition apparatus for use in locating and reading markings on a silicon wafer moving along a path of travel, the apparatus comprising:
a camera positioned along the path of travel at a first angle from vertical with respect to the wafer on the path of travel, the camera adapted to take a plurality of sequential line images of the silicon wafer on the path of travel to produce a first wafer image;
a multiple illumination device positioned along the path of travel at a second angle, the illumination device projects a plurality of different types of illumination that sequentially change in a synchronous manner with the taking of each of the sequential line images; and
a processor in electronic communication with the camera and the illumination device, the processor including six software components wherein the first software receives the line images, the second, third, and fourth software components function to monitor the camera, the illumination device, and the path of travel rate respectively, the fifth software component functions to separate the first wafer image into a plurality of wafer images of different illumination type, and to locate an edge, notch, center and mark area of the wafer, and the sixth software component functions to read the wafer mark.

15. A method of non-oriented optical character recognition for use in locating and reading markings on a silicon wafer traveling along a first path of travel, the method comprising:
generating a single wafer image through sequentially taking a plurality of line images of the wafer and sequentially projecting alternating types of illumination in the area of the line image producing a single wafer image of sequential line images of alternating types of illumination;
locating an area on the wafer containing the wafer markings; and
reading the wafer markings to identify the wafer.

16. The method of claim 15 wherein the step of locating an area on the wafer containing the wafer markings further comprising the steps of separating the single wafer image into individual wafer images having the same illumination and examining at least one of the separated wafer images to locate an edge, a notch on the edge, and the approximate center of the wafer.

17. A method of non-oriented optical character recognition for use in locating and reading markings on a silicon wafer traveling along a first path of travel, the method comprising:
generating a single wafer image of interlaced line images of alternating types of illumination;
separating the interlaced single wafer image into separate wafer images of the same illumination type;
locating an area containing the wafer markings; and
reading the wafer markings to identify the wafer.

18. The method of claim 17 wherein the step of generating the interlaced single wafer image further comprises the step of sequentially taking a plurality of line images of the wafer using a camera positioned in visual communication with the wafer along the path of travel.

19. The method of claim 18 wherein the step of generating a single wafer image further comprises the step of projecting at least two sequentially alternating types of illumination in synchronicity with the taking of each sequential line image using a multiple illumination device in visual communication with the line image taken of the wafer.

20. The method of claim 17 wherein the step of locating an area containing the wafer markings further comprising examining at least one of the separated wafer images, selecting at least one of the separated images, locating a notch on the edge of at least one of the selected wafers, and locating the approximate center of the selected images.

21. The method of claim 17 further comprising the step of conducting a geometric transform of the area containing the wafer markings prior to reading the wafer markings to improve visibility of the markings.

22. The method of claim 17 further comprising examining each of the separated images and conducting a geometric transform on the area containing the wafer markings on each of the separated wafer images having different illumination and individually examining the transformed areas containing the wafer markings to determine if the wafer markings can be read on any one of the separated, transformed areas containing the wafer markings.

23. The method of claim 22 further comprising the step of combining at least two of the separated, differently illuminated and transformed areas containing the wafer markings to determine if the wafer markings can be read in the combined areas housing the markings.
